(19) United States
(12) Patent Application Publication
(10) Pub. No.: US 2009/0097230 A1
(43) Pub. Date: Apr. 16, 2009

(54) ILLUMINATION DEVICE AND LIQUID CRYSTAL DISPLAY DEVICE

(75) Inventors: Takeshi Masuda, Nara (JP); Atsuyuki Tanaka, Nara (JP); Yukihiro Sumida, Nara (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/278,032

(22) PCT Filed: Sep. 28, 2006
(86) PCT No.: PCT/JP2006/319343

§ 371 Date: Nov. 18, 2008

(30) Foreign Application Priority Data
Feb. 3, 2006 (JP) 2006-27753

(51) Int. Cl. G02F 1/13357; F21V 33/00

(52) U.S. Cl. 362/97.2; 362/235

(57) ABSTRACT

A backlight device includes a light diffusing member above a plurality of light sources that are partitioned into a plurality of illumination regions by a partition wall. A light incidence plane at which lights from the plurality of light sources enter is higher than the light sources and equal to or lower than a top of a partition wall. Moreover, a second light diffusing member is laminated above the light diffusing member so that a space is provided between the second light diffusing member and the first light diffusing member. The second light diffusing member has a light incidence plane in a position at a height that is higher than the top of the partition member. This makes it possible to independently control each of the illumination regions.

### BACKGROUND OF THE INVENTION

1. Field of the Invention

The present invention relates to an illumination device including a plurality of light sources and a liquid crystal display device including the illumination device as a backlight device.

2. Description of the Related Art

A liquid crystal display device is characterized by small thickness, low power consumption, and high definition. According to an increase in a screen size of the liquid crystal device due to development of manufacturing technology, the liquid crystal display device is prevailing in the field of television in which field a cathode ray tube (CRT) is conventionally common.

However, regarding an image displayed by the liquid crystal display device, problems concerning an image quality are indicated. For example, due to a display method of the liquid crystal display device, a perceived contrast (dynamic range) of such an image is lower than that of an image displayed by a CRT, and an image blurs at the time when a moving image is displayed. Accordingly, in recent years, techniques for improving an image quality have been actively developed.

For example, Patent Document 1 discloses a liquid crystal display device that improves a perceived contrast (dynamic range) of an image by controlling, in accordance with a display image, a luminance of an illumination light of a backlight device (illumination section).

With the use of this technique that is disclosed in Patent Document 1, the backlight device is arranged to include a plurality of illumination regions whose luminances are independently controllable and simultaneously the liquid crystal display device is arranged to virtually include a plurality of display regions corresponding to the respective illumination regions of the backlight device. Further, in such arrangements, a luminance of an illumination light in each of the illumination regions in the backlight device is controlled in accordance with a tone of an image displayed in the corresponding display region of the liquid crystal display device. This extends a dynamic range. As a result, it becomes possible to realize a liquid crystal display device capable of displaying an image whose perceived contrast is high.

The phrase “To control, in accordance with a tone of an image displayed in the corresponding display region of the liquid crystal display device, a luminance of an illumination light in each of the illumination regions in the backlight device” is rephrased as “to control a luminance of an illumination light so that the luminance becomes a high luminance in an illumination region corresponding to a display region in which a bright image is displayed and the luminance becomes a low luminance in an illumination region corresponding to a display region in which a dark image is displayed”.

One example of the backlight device including the plurality of illumination regions is a direct backlight device 110 as illustrated in FIG. 15. The backlight device 110 includes a plurality of light sources 111. Each partition wall 112 partitions between the light sources 111. As a result, a plurality of illumination regions 113 are formed.

Patent Document 2 discloses a liquid crystal display device that improves moving image display performance by controlling timing of lighting/non-lighting of the backlight device, according to an input signal of a display image.

In the liquid crystal display device, an illumination device includes a plurality of illumination regions whose lighting/non-lighting can be independently controlled, and simultaneously a liquid crystal display section virtually includes a plurality of display regions respectively corresponding to the illumination regions of the illumination device. A control device carries out control such that (i) illumination of each of the illumination regions is turned off until scanning of the display regions is completed and a liquid crystal responds and (ii) the illumination is turned on after the liquid crystal responds. This makes it possible to realize a liquid crystal display device that is excellent in a moving image display performance, with the use of a so-called impulse type display system.

FIG. 16 illustrates a direct backlight device 120, as disclosed in Patent Document 2, which direct backlight device 120 includes a plurality of illumination regions 121. Each partition wall 122 partitions between the light sources 121. As a result, a plurality of illumination regions 124 are formed. The back light device 120 further includes, on a light emitting side, a light diffusing plate 123 that diffuses light.

FIG. 17 illustrates a direct backlight device 130 as described in Patent Document 3, which direct backlight device 130 includes a plurality of illumination regions. The backlight device 130 includes a plurality of light sources 131 whose wavelengths (colors) are different one another, for example, a red LED (Light Emitting Diode) light source 131R, a green LED light source 131G, and a blue LED light source 131B. The plurality of light sources 131 are arranged such that each set includes three colors including red, green, and blue, and are partitioned, by a partition wall 132 (132-1, 132-2), into each illumination region 134 (134-1, 134-2, 134-3). The direct backlight device 130 includes, on a light emitting side, a light diffusing sheet 133 that diffuses light.

However, in an arrangement where a plurality of light sources 131 are provided in one of the illumination regions 134 as mentioned above, luminance unevenness occurs, when all the illumination regions 134 are lit at the same brightness in a case where the a height h of the partition wall 132 that partitions each of the luminance regions 134 is close to a height H at which the light diffusing sheet 133 is provided. This is because a section corresponding to a section above the partition wall 132 becomes a dark section.

Meanwhile, as illustrated in FIG. 17, the height H at which the light diffusing sheet 133 is provided is arranged to be higher than the height h of the partition wall 132. This arrangement produces a space between the partition wall 132 and the light diffusing sheet 133, and lights from the respective light sources 131 cross one another above the partition wall 132. This makes it possible to obtain a uniform illumination light in which the luminance unevenness is eliminated, even in a case where all the illumination regions 134 are lit at the same brightness.

### [Patent Document 1]

Japanese Unexamined Patent Publication No. 40390/2002 (Tokukai 2002-40390 (published on Feb. 6, 2002))

### [Patent Document 2]

Japanese Unexamined Patent Publication No. 128561/2005 (Tokukai 2005-128561 (published on May 19, 2005))

### [Patent Document 3]

Japanese Unexamined Patent Publication No. 39300/1998 (Tokukaihei 10-39300 (published on Feb. 13, 1998))

However, in a conventional liquid crystal display device including a backlight device 130 that, as illustrated in FIG. 17, has an arrangement in which a plurality of light sources 131 are partitioned into a plurality of illumination regions 134 and simultaneously more than one light source 131 is provided in each of the illumination regions 134, an outline is produced in the vicinity of a partition wall 132 when a luminance or lighting/non-lighting of each illumination region of the backlight device 130 is independently controlled for the purpose of improving an image quality. This causes a problem of deterioration in a display quality. In a case where light sources 131 of different wavelengths (colors) are provided in an illumination region, a colored outline is produced according to the wavelengths.

For example, when a center illumination region 134-1 is in a bright state (lighting) and illumination regions 134-2 and 134-3 on both sides of the center illumination region 134-1 are in a dark state (not lighting), a colored outline is produced in the vicinity of each of the partition walls 132-1 and 132-2 that partition the center illumination region 134-1 from the illumination regions 134-2 and 134-3 that are provided on both sides of the center illumination region 134-1.

An upper part of FIG. 17 illustrates a state of an outline that is produced in the vicinity of the partition wall 132-1 that partitions between the center illumination region 134-1 and the illumination region 134-2 that is provided on a right side of the center illumination region 134-1. As illustrated in the upper part of FIG. 17, a yellow outline is produced outside a white region and a red outline is produced further outside the yellow outline.

Such outlines are caused by a space between the partition wall 132 and a diffusing sheet 133 which space is capable of eliminating luminance unevenness due to the partition wall 132 in a case where all the illumination regions 134 are lit at the same brightness.

In other words, because the space is provided between the partition wall 132 and the light diffusing sheet 133, regions on the light diffusing sheet 133 in which regions, lights projected from the respective light sources 131 differ from one another due to each difference in positional relationship between the partition wall 132 and each of the light sources 131 (i.e., red LED light source 131R, green LED light source 131G, and blue LED light source 131B) in the illumination region 134.

In this case, a projection region of the red LED light source 131R that is provided close to the partition wall 132-2 becomes narrow on the left side where the partition wall 132-2 is provided and wide on the right side where the partition wall 132-1 is provided in a farther position. On the other hand, a projection region of the blue LED light source 131B that is provided close to the partition wall 132-1 is narrow on the right side where the partition wall 132-1 is provided and wide on the left side where the partition wall 132-2 is provided in a farther position. A projection region of the green LED light source 131G that is provided in a position at an equal distance from both of the partition walls 132-1 and 132-2 is identical on both sides where the partition walls 132-1 and 132-2 are provided, respectively.

This produces, in the vicinity of the partition wall 132-1, (i) a yellow region Y1 showing a yellow color in response to projection of red and green colors, on an outer periphery of a white region W1 showing a white color in response to projection of three color lights of red, green, and blue, and, (ii) a red region R1 in which a red color is projected, further on an outer periphery of the yellow region Y1, in this order. As a result, a colored outline is formed. Meanwhile, the case explained above also produces, in the vicinity of the partition wall 132-2, (i) a cyan region showing a cyan color in response to projection of blue and green colors, on an outer periphery of a white region W1 showing a white color in response to projection of three color lights of red, green and blue, and, (ii) a blue region in which a blue color is projected, further on an outer periphery of the cyan region, in this order. As a result, a colored outline is formed.

Further, as illustrated in FIG. 18, a backlight device 136 is arranged such that an illumination region 134 is provided with a plurality of white light sources 131W of the same wavelength (color) and the white light sources 131W are partitioned by a partition wall 132. In a case where, for example, a center illumination region 134-1 is in a bright state (lighting) and illumination regions that are provided respectively on both sides of the illumination region 134-1 are in a dark state (not lighting) in the backlight device 136, outlines whose states are illustrated in an upper side of FIG. 18 are produced in the vicinity of each of the partition walls 132-1 and 132-2 that partition between the center illumination region 134-1 and the illumination region 134-2 and between the center illumination region 134-1 and the illumination region 134-3, respectively.

### SUMMARY OF THE INVENTION

In order to overcome the problems described above, preferred embodiments of the present invention provide a backlight device that has an arrangement in which a plurality of light sources are partitioned into a plurality of illumination regions and simultaneously more than one light source is provided in each illumination region, and provide a backlight device in which each illumination region can be independently controlled while performance as an illumination device is not deteriorated.

An illumination device according to a preferred embodiment of the present invention includes: a plurality of light sources; a partition wall partitioning the plurality of light sources into a plurality of illumination regions so that one illumination region includes more than one light source; a first light diffusing member provided above the plurality of light sources, the first light diffusing member having a light incidence plane in a position at a height that is (i) higher than the plurality of light sources and (ii) same as or lower than a top of the partition wall; and a second light diffusing member which is provided so as to be laminated above the first light diffusing member so that a space is provided between the second diffusing member and the first diffusing member, the second light diffusing member having a light incidence plane in a position at a height that is higher than the top of the partition wall.

According to the arrangement above, lights from the more than one light source in one illumination region are projected on the first light diffusing member whose light incidence plane is in a position at a height that is (i) higher than the light sources and (ii) the same or lower than the top of the partition wall. This allows the lights to be projected on an identical projection region, regardless of disposed positions of the not more than one light source in the illumination region. As a result, in an arrangement in which the plurality of light sources are partitioned into the plurality of illumination regions and the not more than one light source is provided in one illumination region, an outline due to a disposed position of each light source in an illumination region does not occur in the vicinity of the partition wall even when a luminance or lighting/non-lighting of each illumination region is independently controlled.

Moreover, according to this unique arrangement, the second light diffusing member whose light incidence plane is in a position higher than the top of the partition wall is laminated above the first light diffusing member so that a space is provided between the first light diffusing member and the second light diffusing member. Accordingly, lights from adjacent illumination regions cross each other in the space between the top of the partition wall and the second light diffusing member and diffused by the second light diffusing member. This makes it difficult to produce a dark section in the vicinity of a section above the partition wall even when each illumination region is lit at the same brightness. As a result, a uniform illumination light can be obtained all over the illumination regions.

In other words, according to the above arrangement, in the illumination device having an arrangement in which a plurality of light sources are partitioned into a plurality of illumination regions and not more than one light source is provided in one illumination region, it becomes possible to obtain a uniform illumination light all over the illumination regions even when all the illumination regions are lit at the same brightness. Moreover, it becomes possible to realize an illumination device capable of providing a smooth luminance change that does not produce an outline in the vicinity of the partition wall even when each illumination region is independently controlled.

A liquid display device according to a preferred embodiment of the present invention includes an illumination device by laminating the illumination device on a liquid crystal panel.

As described above, according to the illumination device of a preferred embodiment of the present invention, in an illumination device having an arrangement in which the plurality of light sources are partitioned into the plurality of illumination regions and not more than one light source is provided in one illumination region, a uniform illumination light can be obtained all over the illumination regions in a case where all the illumination regions are lit at the same brightness. Moreover, even when each illumination region is independently controlled, it becomes possible to obtain a smooth illumination change that does not produce an outline in the vicinity of the partition wall. Therefore, by including such an illumination device as a backlight device and controlling, independently, each illumination region, it becomes possible to effectively improve an image quality.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a diagram showing a preferred embodiment of the present invention and illustrating a schematic configuration of a substantial portion of a liquid crystal display device.

FIG. 2 is a diagram illustrating a schematic configuration of a backlight device provided in the liquid crystal display device.

FIG. 3 is a plan view illustrating a substantial portion of the backlight device.

FIG. 4 is an explanatory diagram illustrating an arrangement of a measurement system in which a substantially parallel light from a directional light source is entered into a light diffusing member at an incident angle of 0° and distribution of angles of a transmitted light from the light diffusing member is measured by a light receiver.

FIG. 5 is an explanatory diagram illustrating a relationship between an incident angle and a relative intensity of a light from the directional light source that enters the light into the light diffusing member at an incident angle of 0°.

FIG. 6 is an explanatory diagram illustrating a relationship between an exit angle and a relative intensity of each of transmitted lights (diffused lights) obtained in a case where substantially parallel lights that are from the directional light source and have a characteristic of FIG. 5 are entered into the first and second light diffusing members at an incident angle of 0°, respectively.

FIG. 7 is a diagram showing another preferred embodiment of the present invention and schematically illustrating a backlight device provided in the liquid crystal display device.

FIG. 8 is a plan view illustrating a substantial portion of the backlight device.

FIG. 9 is an explanatory diagram illustrating a projection region of a light from each light source which projection region is on a first light diffusing member and a relationship between a position and a luminance of an emitted light from a second light diffusing member, in a case where one illumination region is set in a bright state (lighting) and other illumination regions are set in a dark state (not lighting) in a backlight device of one example of a preferred embodiment of the present invention.

FIG. 10 is an explanatory diagram illustrating a projection region of a light from each light source which projection region is on a first light diffusing member and a relationship between a position and a luminance of an emitted light from a second light diffusing member, in a case where one illumination region is set in a bright state (lighting) and other illumination regions are set in a dark state (not lighting) in a backlight device of another example of a preferred embodiment of the present invention.

FIG. 11 is an explanatory diagram illustrating a projection region of a light from each light source which projection region is on a first light diffusing member and a relationship between a position and a luminance of an emitted light from a second light diffusing member, in a case where one illumination region is set in a bright state (lighting) and other illumination regions are set in a dark state (not lighting) in a backlight device of a comparative example of the present invention.

FIG. 12 is an explanatory diagram illustrating a projection region of a light from each light source which projection region is on a first light diffusing member and a relationship between a position and a luminance of an emitted light from a second light diffusing member, in a case where one illumination region is set in a bright state (lighting) and other illumination regions are set in a dark state (not lighting) in a backlight device of another example of a preferred embodiment of the present invention.

FIG. 13 is an explanatory diagram illustrating a projection region of a light from each light source which projection region is on a first light diffusing member and a relationship between a position and a luminance of an emitted light from a second light diffusing member, in a case where one illumination region is set in a bright state (lighting) and other illumination regions are set in a dark state (not lighting) in a backlight device of another example of a preferred embodiment of the present invention.

FIG. 14 is an explanatory diagram illustrating a projection region of a light from each light source which projection region is on a first light diffusing member and a relationship between a position and a luminance of an emitted light from a second light diffusing member, in a case where one illumination region is set in a bright state (lighting) and other illumination regions are set in a dark state (not lighting) in a backlight device of another comparative example of the present invention.

FIG. 15 is an oblique view showing a conventional technique and illustrating a substantial part of a direct backlight device.

FIG. 16 is a cross sectional view showing a conventional technique and illustrating a substantial part of another direct backlight device.

FIG. 17 is an explanatory diagram showing a conventional technique and illustrating a cross-sectional arrangement of another direct backlight device, and a projection region of a light from each light source which projection region is on a light diffusing member and a relationship between a position and a luminance of an emitted light from a light diffusing member, in a case where one illumination region is set in a bright state (lighting) and other illumination regions are set in a dark state (not lighting)).

FIG. 18 is an explanatory diagram showing a conventional technique and illustrating a cross-sectional arrangement of another direct backlight device, and a projection region of a light from each light source which projection region is on a light diffusing member and a relationship between a position and a luminance of an emitted light from a light diffusing member, in a case where one illumination region is set in a bright state (lighting) and other illumination regions are set in a dark state (not lighting)).

### DETAILED DESCRIPTION OF PREFERRED EMBODIMENTS

### Preferred Embodiment 1

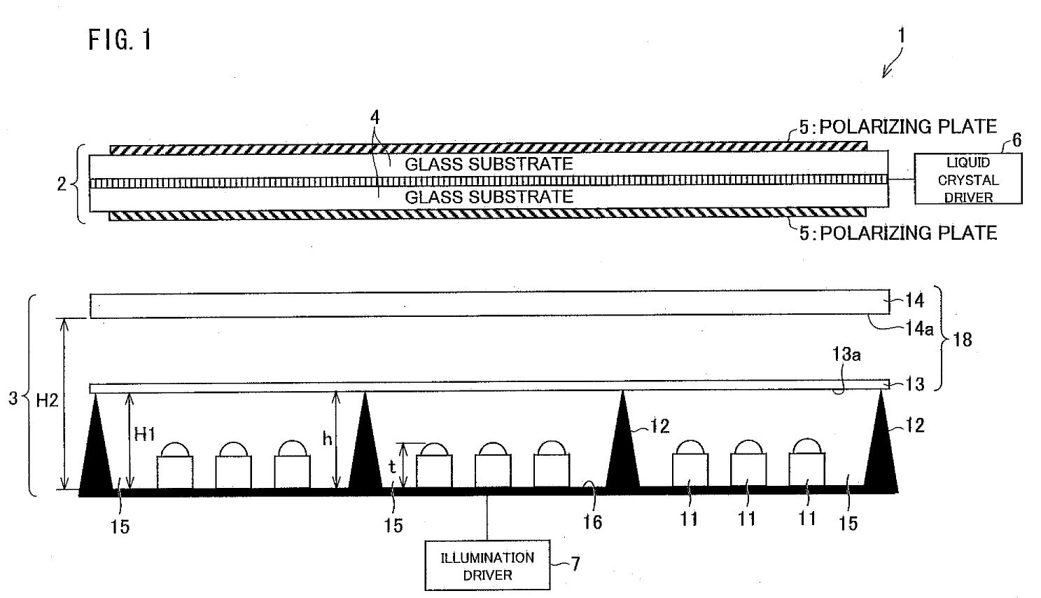

The following explains a preferred embodiment of the present invention, with reference to FIGS. 1 through 6.

FIG. 1 is a diagram illustrating a schematic configuration of a substantial portion of a liquid crystal display device. As illustrated in FIG. 1, a liquid crystal display device 1 of Preferred Embodiment 1 of the present invention includes a liquid crystal panel 2, a liquid crystal driver 6, a backlight device 3 that is an illumination device, and an illumination driver 7.

The liquid crystal panel 2 has an arrangement including a pair of glass substrates 4 that are bonded each other at respective peripheries, and a pair of polarizing plates 5 that are provided respectively on outer surfaces of the respective glass substrates 4. Between the glass substrates 4, a liquid crystal layer is sealed and a color filter layer, a TFT array, and the like are formed, though not specifically illustrated.

In a case where the liquid crystal panel 2 is, for example, an active matrix type, pixels are provided in a matrix so as to correspond to respective intersections of a plurality of scanning lines and a plurality of signal lines. A TFT (switching element) is provided so as to correspond to each of the pixels. The liquid crystal driver 6 selects a TFT with the use of a panel scanning signal line. A display signal is supplied to a pixel electrode corresponding to each pixel from a signal line via the selected TFT. In this way, an image is displayed by controlling a transmissivity of a liquid crystal of each pixel.

A configuration of the liquid crystal panel 2 is not limited to the configuration illustrated. Depending on a drive mode, it is possible to use various types of liquid crystal panels, for example, a liquid crystal panel that does not include the polarizing plate 5 or a liquid crystal panel that includes the number other than 2 of the polarizing plate 5.

The backlight device 3 is provided on a backside of the liquid crystal panel 2 so as to illuminate the liquid crystal panel 2 from the backside of the liquid crystal panel 2. Here, the backlight device 3 is partitioned into a plurality of illumination regions for the purpose of improving an image quality. The illumination driver 7 controls the backlight device 3 so that each illumination region of the backlight device 3 illuminates the liquid crystal panel 2.

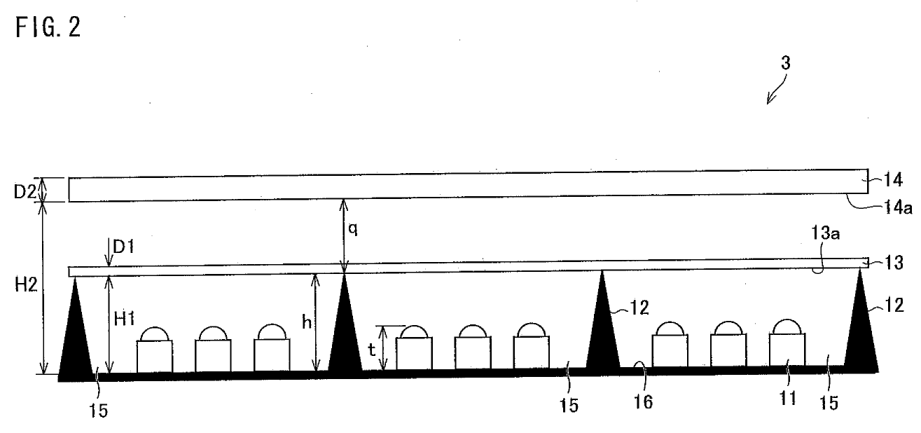

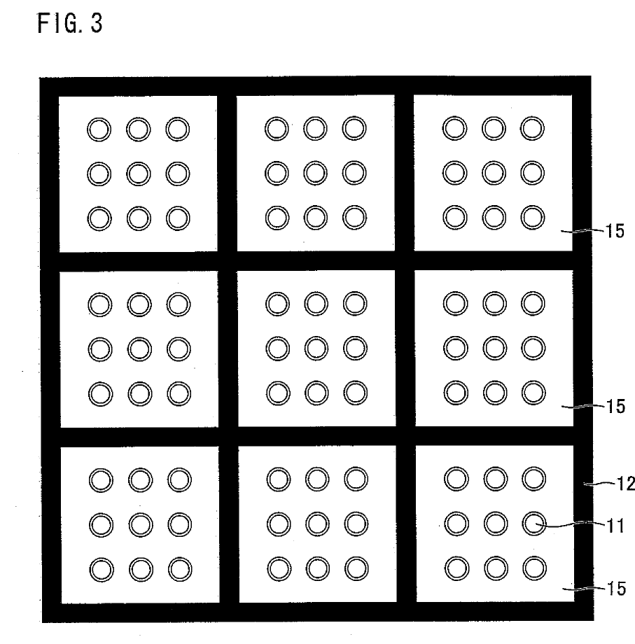

FIG. 2 is a diagram schematically illustrating the backlight device 3. FIG. 3 is a plan view of a substantial portion of the backlight device 3.

The backlight device 3, as illustrated in FIG. 2, includes a plurality of white light sources 11, a partition wall 12 that partitions the plurality of light sources 11 into a plurality of illumination regions, and light diffuser 18 that is stacked on an upper side of the plurality of light sources 11 and diffuses light from the plurality of light sources 11.

The plurality of light sources 11 are provided on a light source disposition surface 16. A disposition space on the light source disposition surface 16 is partitioned by the partition wall 12, and the plurality of light sources 11 are partitioned into a plurality of illumination regions 15. One example of the light source 11 is an LED, but other light source showing a white color may be employed.

The partition wall 12 partitions the light source disposition surface 16 so that the light source disposition surface 16 is partitioned into a plurality of illumination regions and each illumination region 15 includes more than one light source 11. Here, the partition wall 12 is in the form of a lattice and partitions the disposition surface 16 preferably into 9 illumination regions 15, for example. In each illumination region 15 preferably in a square form, 9 (3 (vertical)×3 (horizontal)) light sources 11 in total are preferably provided, for example. Further, a thickness of the partition wall 12 decreases, as a position of the partition wall 12 becomes higher with respect to the light source disposition surface 16. The cross section of the partition wall 12 is a sharp isosceles triangle.

The light diffuser 18 is provided above the plurality of light sources 11. The light diffuser 18 is preferably made of a plurality of light diffusing members that are laminated so as to be spaced apart from one another. The number of the light diffusing members constituting the light diffuser 18 and spaces between the light diffusing members may be determined so as to satisfy the following conditions: (i) in a case where each illumination region 15 is independently controlled, an outline does not occur in the vicinity of the partition wall 12; and (ii) in a case where all the illumination regions 15 are lit at the same brightness, a section in the vicinity of a section above the partition wall 12 does not become a dark section.

However, because a light transmittance deteriorates as the number of the light diffusing members laminated increases, it is preferable that the light diffuser 18 includes two light diffusing members, for example. The present preferred embodiment realizes the light diffuser 18 by using two light diffusing members whose number is the minimum number 2. In the present preferred embodiment, a first diffusing member 1 provided closer to the light source 11 and a light diffusing member 14 provided farther from the light source 11 are laminated so as to be spaced apart from each other.

The first light diffusing member 13 that is provided on the side provided with the light source 11 diffuses a light from each light source 11. The first light diffusing member 13 is provided so that a position of a light incidence plane 13a at which the light from each light source 11 enters becomes higher than the light source 11 and equal to or lower than a top of the partition wall 12.

That is, the first diffusing member 13 satisfies a relationship t<H1≦h (first condition), where: H1 is a height of the first light diffusing member 13 from the light source disposition surface 16 to the light incidence plane 13a; t is a height of the light source 11 from the light source disposition surface 16; and h is a height of the partition member 12 from the light source disposition surface 16.

The second light diffusing member 14 further diffuses the light that is diffused by the first light diffusing member 13. A space is provided between the second light diffusing member 14 and the first light diffusing member 13, and a light incidence plane 14a is provided at a position higher than the top of the partition wall 12.

That is, the second light diffusing member 14 satisfies H2>h (second condition), where: H2 is a height of the second light diffusing member 14 from the light source disposition surface 16 to the light incidence plane 14a; and h is a height of the partition wall 12 from the light source disposition surface 16. Here, it is more preferable that a height q from the top of the partition wall 12 to the light incidence plane 14a of the second light diffusing member 14 is set to a height that makes it possible to solve a problem in that a section in the vicinity of the upper surface of the partition wall 12 becomes dark (more preferable second condition).

By satisfying the first condition above in disposition of the first light diffusing member 13, a projection region of each light source 11 on the first light diffusing member 13 which light source 11 is in the illumination region 15 may be arranged to be the same, regardless of a position in which the light source is provided.

As a result, in the backlight device 3 which is partitioned into a plurality of illumination regions 15 and in which a plurality of light sources 11 are provided in one illumination region 15, an outline in accordance with a position where the light source 11 is provided in the illumination region 15 does not occur in the vicinity of the partition wall 12, even when a luminance or lightning/non-lighting of each illumination region 15 is independently controlled by the illumination driver 7.

Moreover, by satisfying the second condition above in disposition of the second light diffusing member 14, the illumination lights from the adjacent illumination regions 15 cross each other in a space that is provided above the partition wall 12 and is from the top of the partition wall 12 to the light incidence plane 14a of the second light diffusing member 14. Then, the illumination lights are projected on the second light diffusing member 14. Therefore, even when the illumination regions 15 are lit at the same brightness, it becomes difficult to produce a dark section in the vicinity of a section above the partition wall 12. Accordingly, a uniform illumination light all over the illumination regions can be obtained. In this case, by satisfying the more preferable second condition, a section in the vicinity of a section above the partition wall 12 never becomes a dark section even when each illumination region 15 is lit at the same brightness. As a result, a more uniform illumination light can be obtained all over the illumination regions 15.

Further, in the light diffuser 18 that includes a plurality of light diffusing members as mentioned above, it is more preferable for the purpose of eliminating luminance unevenness to select each light diffusing member so that any one of the following requirements is satisfied.

Requirement 1: The light diffusing members are selected so that Haze ratios (%) of the plurality of light diffusing members constituting the light diffuser 18 become such that a light diffusing member provided farther from the light source 11 has a higher Haze ratio (%) (The requirement 1 includes a case where the light diffusing members have an equal Haze ratio (%)). In an arrangement that is made of the first and second light diffusing members 13 and 14, the light diffusing members are selected so that 0<HZ1≦HZ2<100, where: HZ1 is a Haze ratio (%) of the first light diffusing member 13; and HZ2 is a Haze ratio (%) of the second light diffusing member 14.

Requirement 2: The light diffusing members are selected so that linear light transmittances (%) of the plurality of light diffusing members constituting the light diffuser 18 become such that a light diffusing member provided closer to the light source 11 has a higher linear light transmittance (%) (The requirement 2 includes a case where the light diffusing members have an equal linear light transmittance (%)). In an arrangement that is made of the first and second light diffusing members 13 and 14, the light diffusing members are selected so that 0<T2≦T1<100, where: T1 (%) is a linear light transmittance of the first light diffusing member 13; and T2 is a linear light transmittance (%) of the second diffusing member 14.

Requirement 3: The light diffusing members are selected so that full widths θ (deg) at half maximum of transmitted diffusion lights that are obtained by entering substantially parallel lights into the plurality of respective light diffusing members constituting the light diffuser 18 become such that a transmitted diffusion light from a light diffusing member provided closer to the light source 11 has a larger full width (deg) at half maximum (The requirement 3 includes a case where the transmitted diffusion lights from the light diffusing members have an equal full width (deg) at half maximum). In an arrangement including the first and second light diffusing members 13 and 14, the light diffusing members are selected so that 0<θ1≦θ2<180, where: θ1 (deg) is a full width at half maximum of a transmitted diffusion light obtained by entering a substantially parallel light into the first light diffusing member 13; and θ2 (deg) is a full width at half maximum of a transmitted diffusion light obtained by entering a substantially parallel light into the second diffusing member 14.

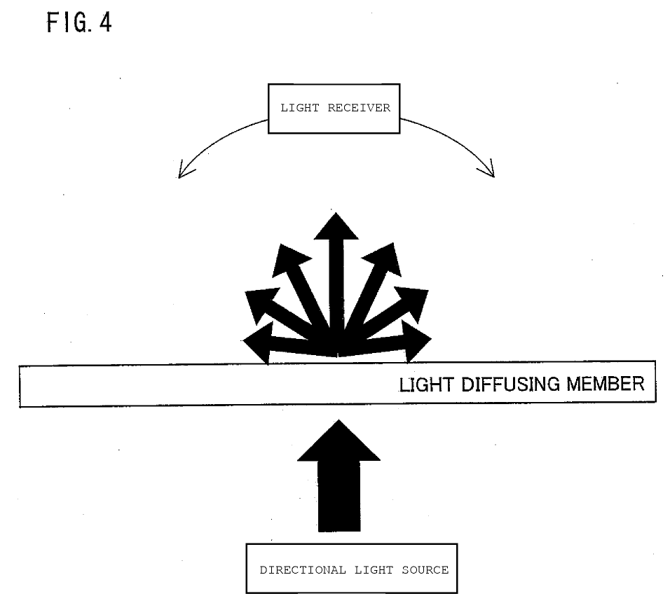

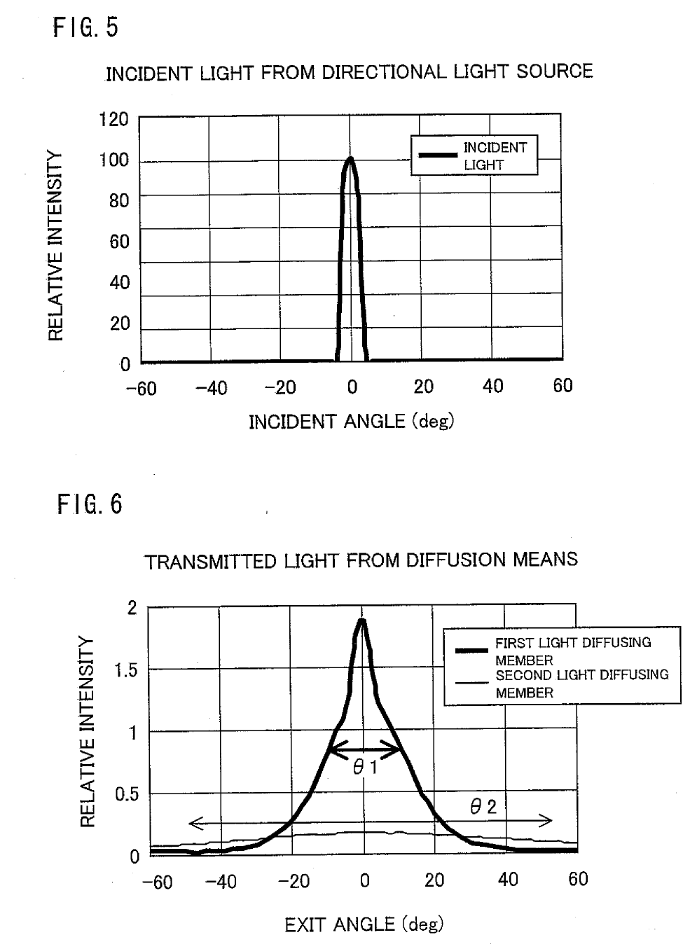

Here, the following explains the requirements 2 and 3. In the arrangement as illustrated in FIG. 4, substantially parallel lights from a directional light source is entered into a light diffusing member at an incident angle of 0° and distribution of angles of transmitted lights from the light diffusing member is measured by a light receiver. When the substantially parallel lights that have a characteristic as illustrated in FIG. 5 are entered into the first light diffusing member 13 and the second light diffusing member 14, respectively, at an incident angle of 0°, the transmitted lights from the light diffusing members 12 and 14 become diffused lights, respectively, as illustrated in FIG. 6. In FIG. 6, a thick line shows a transmitted light from the first light diffusing member 13 and a thin line shows a transmitted light from the second light diffusing member 14.

In a result as illustrated in FIG. 6, transmittances of the respective first and second light diffusing members 13 and 14 are considered. An intensity of the substantially parallel light that is entered in a direction at an incident angle of θ0 is assumed to be 100, and an intensity of a light in a direction at an exit angle of 0° which light has transmitted through the first light diffusing member 13 is defined as a linear light transmittance. Then, a linear light transmittance T1 becomes equal to 1.9(%). In the same manner, an intensity of light in a direction at an exit angle of 0° which light has transmitted through the second light diffusing member is defined as a linear light transmittance. Then, the linear light transmittance T2 becomes equal to 0.17(%). This satisfies 0<T2≦T1<100 that is the requirement 2 mentioned above.

Next, in the result of FIG. 6, full widths of half maximum of the respective diffused lights that have transmitted through the first and second light diffusing members 13 and 14, respectively, are considered. The full width θ1 of half maximum of the diffused light having passed through the first light diffusing member 13 is about 16 degrees, and the full width θ2 of half maximum of the diffused light having passed through the second light diffusing member 14 is about 108 degrees, for example. Therefore, this satisfies 0<θ1≦θ2<180 (deg) that is required in the requirement 3.

By satisfying any one of such requirements 1 through 3, the light from each light source 11 is efficiently diffused by the plurality of light diffusing members laminated in the light diffuser 18 including the plurality of light diffusing members. As a result, luminance unevenness can be eliminated.

As described above, the backlight device 3 provided in the liquid crystal display device 1 of the present preferred embodiment 3 includes a plurality of illumination regions 15 partitioned by the partition wall 12 and includes the plurality of light sources 11 in each of the illumination regions 15. Even in such an arrangement, the backlight device 3 includes the light diffuser 18 including the first and second light diffusing members 13 and 14 that satisfy the above-mentioned disposition condition. This makes it possible to obtain a uniform illumination light all over the illumination regions 15 when all the illumination regions 15 are lit at the same brightness. In addition, it becomes possible to obtain a smooth luminance change in which an outline does not occur in the vicinity of the partition wall 12 even in a case where each of the illumination regions 15 is independently controlled.

Accordingly, in the liquid crystal display device 1 of the present preferred embodiment including such a backlight device 3, an image quality can be effectively improved by controlling each illumination region 15 independently.

In the backlight device 3 of the present preferred embodiment, an arrangement in which the first light diffusing member 13 is in touch with the partition wall 12 is explained as an example of an arrangement in which a height of the light incidence plane 13a of the first light diffusing member 13 is the same as the top of the partition wall 12. However, it is difficult to hold the first light diffusing member 13 so that a whole surface of the light diffusing member 13 is in touch with the partition wall 12. Therefore, the arrangement in which a height of the light incidence plane 13a of the first light diffusing member 13 is the same as the top of the partition wall 12 may be an arrangement such that a portion of the first light diffusing member and a portion of the partition wall 12 are in touch with each other.

The present preferred embodiment shows the liquid crystal display device 1 as an example. The present preferred embodiment also shows, as an example of an illumination device, the backlight device 3 that illuminates the liquid crystal panel 2 from a backside of the liquid crystal panel 2. However, it is clearly possible to use the backlight device 3 that includes the above arrangement as other illumination device, other than for the purpose of illuminating the liquid crystal panel 2.

### Second Preferred Embodiment 2

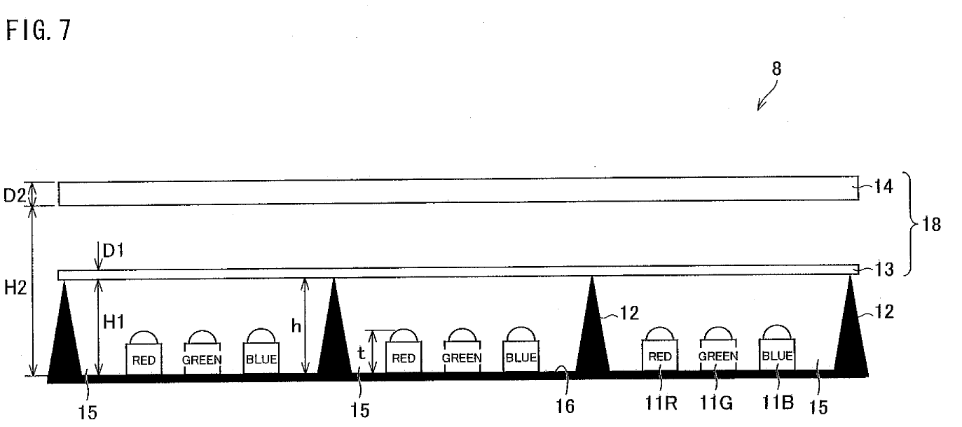

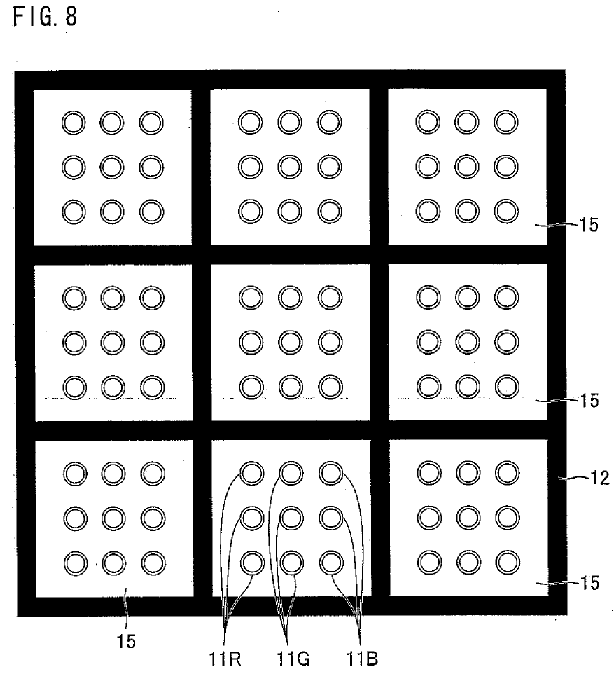

The following explains another preferred embodiment of the present invention, with reference to FIGS. 7 and 8.

FIG. 7 is a diagram illustrating a schematic configuration of a substantial portion of a backlight device in a liquid crystal device of the present preferred embodiment. FIG. 8 is a plan view illustrating a substantial portion of a backlight device 8.

The liquid crystal display device of Preferred Embodiment 2 is different from a liquid crystal display device 1 of Preferred Embodiment 1 in that the liquid crystal display device of Preferred Embodiment 2 includes the backlight device 8 in lieu of the backlight device 3. The backlight 8 is different from the backlight device 3 in light sources provided on a light source disposition surface 16.

That is, though the backlight device 3 includes a plurality of white light sources 11, the backlight device 8 has an arrangement in which a plurality of red light sources 11R, a plurality of green light sources 11G, and a plurality of blue light sources 11B are provided as illustrated in FIG. 8 and an illumination light showing a white color is realized by three colors including red, green, and blue. Here, in one illumination region 15, three red light sources 11R, three green light sources 11G, and three blue light sources 11B are provided. Here, three light sources 11 for each color are provided in one illumination region 15. However, a white illumination light can be realized as long as at least one light source 11 for each color is provided in one illumination region 15.

The backlight device 8 of the above arrangement includes light diffuser 18 that includes first and second light diffusing members 13 and 14, as with the backlight device 3. The first and second light diffusing members 13 and 14 satisfy disposition conditions described above. This makes it possible to obtain a uniform illumination light all over illumination regions 15 in a case where all the illumination regions 15 are lit at the same brightness. Simultaneously, when each illumination region 15 is independently controlled, an outline corresponding to a red, green, blue, or the like wavelength (color) of the light source 11 is not produced in the vicinity of the partition wall 12. This makes it possible to obtain a smooth luminance change.

Therefore, in the liquid crystal display device of the present preferred embodiment including the backlight device 8, as in the liquid crystal display device 1 of Preferred Embodiment 1, an image quality can be effectively improved by controlling each illumination region 15 independently.

As explained above, an illumination device according to a preferred embodiment of the present invention includes: a plurality of light sources; a partition wall partitioning the plurality of light sources into a plurality of illumination regions so that one illumination region includes more than one light source; a first light diffusing member provided above the plurality of light sources, the first light diffusing member having a light incidence plane in a position at a height that is (i) higher than the plurality of light sources and (ii) same as or lower than a top of the partition wall; and a second light diffusing member which is provided so as to be laminated above the first light diffusing member so that a space is provided between the second diffusing member and the first diffusing member, the second light diffusing member having a light incidence plane in a position at a height that is higher than the top of the partition wall.

According to the arrangement above, lights from the more than one light source in one illumination region are projected on the first light diffusing member whose light incidence plane is in a position at a height that is (i) higher than the light sources and (ii) the same or lower than the top of the partition wall. This allows the lights to be projected on an identical projection region, regardless of disposed positions of the not more than one light source in the illumination region. As a result, in an arrangement in which the plurality of light sources are partitioned into the plurality of illumination regions and the not more than one light source is provided in one illumination region, an outline due to a disposed position of each light source in an illumination region does not occur in the vicinity of the partition wall even when a luminance or lighting/non-lighting of each illumination region is independently controlled.

Moreover, according to the arrangement, the second light diffusing member whose light incidence plane is in a position higher than the top of the partition wall is laminated above the first light diffusing member so that a space is provided between the first light diffusing member and the second light diffusing member. Accordingly, lights from adjacent illumination regions cross each other in the space between the top of the partition wall and the second light diffusing member and diffused by the second light diffusing member. This makes it difficult to produce a dark section in the vicinity of a section above the partition wall even when each illumination region is lit at the same brightness. As a result, a uniform illumination light can be obtained all over the illumination regions.

In other words, according to the above arrangement, in the illumination device having an arrangement in which a plurality of light sources are partitioned into a plurality of illumination regions and not more than one light source is provided in one illumination region, it becomes possible to obtain a uniform illumination light all over the illumination regions even when all the illumination regions are lit at the same brightness. Moreover, it becomes possible to realize an illumination device capable of providing a smooth luminance change that does not produce an outline in the vicinity of the partition wall even when each illumination region is independently controlled.

In the illumination device according to a preferred embodiment of the present invention, it is more preferable that a distance between the light incidence plane which the second light diffusing member has and the top of the partition wall is set to a distance that does not produce a dark section in a vicinity of a section above the partition wall in a case where all the plurality of illumination regions are lit at a same brightness.

Further, in the illumination device according to a preferred embodiment of the present invention, it is further preferable that: a Haze ratio of the second light diffusing member is equal to or more than a Haze ratio of the first light diffusing member; a linear light transmittance of the first light diffusing member is equal to or more than a linear light transmittance of the second light diffusing member; and a full width at half maximum of a transmitted diffused light obtained by entering a substantially parallel light into the second light diffusing member is equal to or more than a full width at half maximum of a transmitted diffused light obtained by entering a substantially parallel light into the first light diffusing member.

By satisfying any one of the above requirements, lights from the plurality of respective light sources can be efficiently diffused by the first and second light diffusing members that are provided by lamination. This makes it possible to eliminate luminance unevenness.

In order to solve the problems described above, a liquid display device according to a preferred embodiment of the present invention includes an illumination device by laminating the illumination device on a liquid crystal panel.

As described above, according to the illumination device according to a preferred embodiment of the present invention, in an illumination device having an arrangement in which the plurality of light sources are partitioned into the plurality of illumination regions and not more than one light source is provided in one illumination region, a uniform illumination light can be obtained all over the illumination regions in a case where all the illumination regions are lit at the same brightness. Moreover, even when each illumination region is independently controlled, it becomes possible to obtain a smooth illumination change that does not produce an outline in the vicinity of the partition wall. Therefore, by including such an illumination device as a backlight device and controlling, independently, each illumination region, it becomes possible to effectively improve an image quality.

### Example 1

The following explains one example of a backlight device 3 of Preferred Embodiment 1. In an arrangement of the backlight device 3, NCCW022S (part number) fabricated by Nichia Corporation was used as each of a plurality of light sources 11. A size of the light source was φ 10 mm×10 mm (height). As a first light diffusing member 13, OPALUS BS-01 (product name) fabricated by Keiwa Inc. was used. As a second light diffusing member 14, CL AREX DR-IIIC DR-60C (product name) fabricated by Nitto Resin Corporation was used. Regarding the OPALUS that was used as the first diffusing member 13, a thickness D1 was 0.125 (mm) and a Haze ratio was 87(%). On the other hand, regarding the CLAREX DR-IIIC DR-60C that was used as the second diffusing member 14, a thickness D2 was 2.0 (mm) and a Haze ratio was 96(%).

A height h of a partition wall 12 from a light source disposition surface 16 was arranged to be 25 (mm). The first light diffusing member 13 was arranged so as to be in touch with the partition wall 12 and a height H1 of the first light diffusing member 13 from the light source disposition surface 16 to a light incidence plane 13a of the first light diffusing member 13 was arranged to be 25 (mm). A height H2 of the second light diffusing member 14 from the light source disposition surface 16 to a light incidence plane 14a was arranged to be 40 (mm). In this case, a height q from a top of the partition wall 12 to the light incidence plane 14a was approximately 15 (mm) that was obtained by q=H2−(h+D1). Moreover, an interval of the partition wall 12 was 55 mm and the number of light sources provided in one illumination region 15 was set to 9.

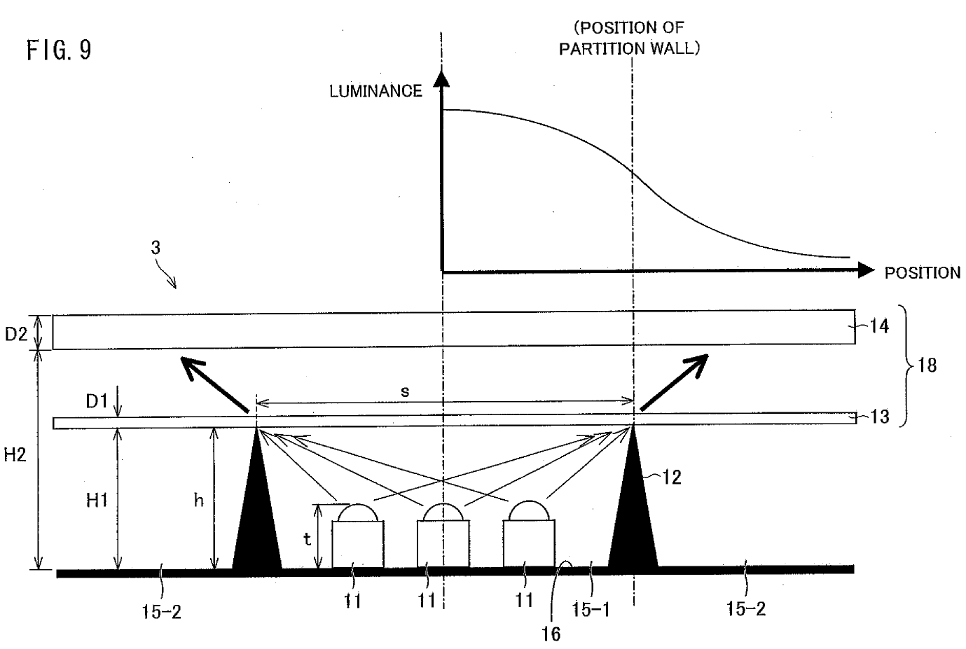

FIG. 9 illustrates a projection region of light from the light source 11 in the backlight device 3 of Example 1 which projection region was obtained when one illumination region 15-1 was set in a bright state (lighting) and other illumination regions 15-2 were set in a dark state (non-lighting). An upper part of FIG. 9 illustrates a result of study on a relationship between a position and a luminance of an emitted light from the second light diffusing member 14.

The light from each light source 11 in the illumination region 15-1 in a bright state was first projected on the first light diffusing member 13. At this time, the projection region S of each light source 11 was identical. Accordingly, in an illumination light that had passed through the first light diffusing member 13 and was projected on the second light diffusing member 14, an outline did not occur. As a result, a smooth luminance change as shown in an upper portion of FIG. 9 was obtained.

### Example 2

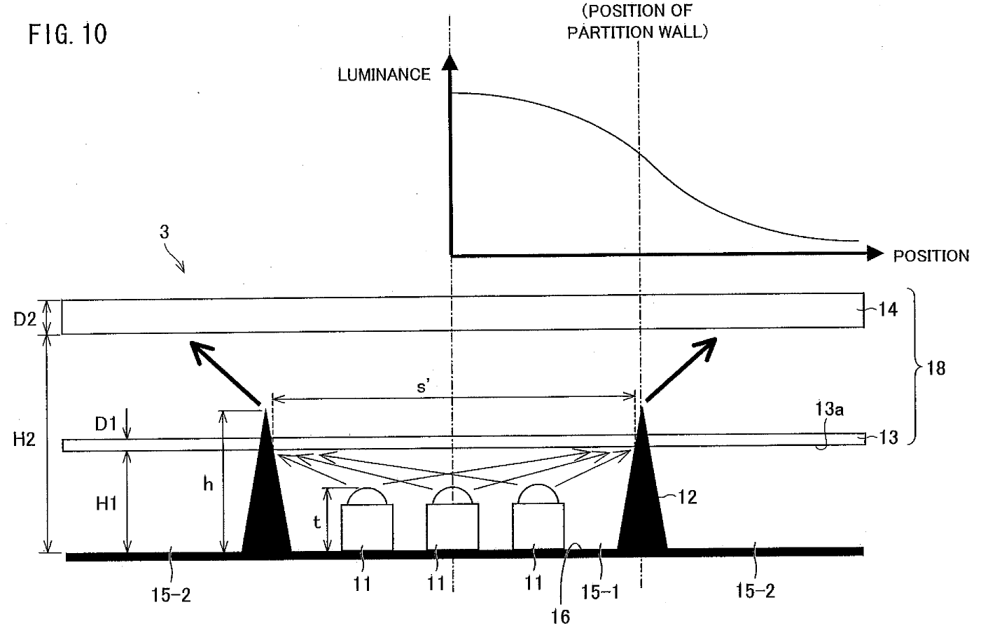

The following explains another example of a backlight device 3 of Preferred Embodiment 1. The present example was different from Example 1 in a height at which a first light diffusing member 13 was provided. Here, as illustrated in FIG. 10, a light incidence plane 13a of the first diffusing member 13 was provided in a position lower than a top of a partition wall 12. While a height h of the partition wall 12 from a light source disposition surface 16 was 25 (mm), a height H1 from the light source disposition surface 16 to the light incidence plane 13a of the first light diffusing member 13 was arranged to be 20 (mm). A height q (q=H2−h) of the second light diffusing member 12 from the top of the partition wall 12 to a light incidence plane 14a was 15 (mm).

As with Example 1, in this case, a projection region S′ of a light on the first light diffusing member 13 from each light source 11 in an illumination region 15-1 in a bright state was identical. Therefore, an outline was not produced in an illumination light projected on the second light diffusing member 14. As a result, a smooth luminance change as illustrated in an upper part of FIG. 10 was obtained.

### Comparative Example 1

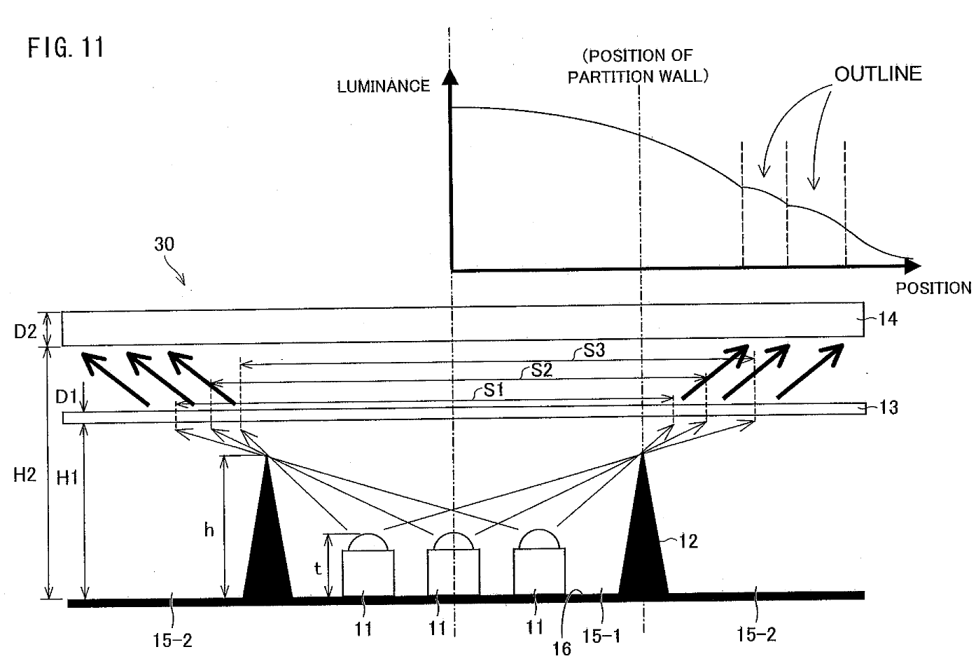

Meanwhile, in a backlight device 30 of a comparative example, a first light diffusing member 13 was provided in a position higher than a partition wall 12. In the backlight device 30, as illustrated in FIG. 11, projection regions s1, s2, and s3 of lights on the light diffusing member 13 from light sources 11 in the illumination region 15-1 in a bright state differed from one another, depending on respective positions of the light sources in the illumination region 15-1. Therefore, as illustrated in an upper part of FIG. 11, an outline was produced in an illumination light that was projected on a second light diffusing member 14. As a result, a uniform illumination was not obtained.

### Example 3

The following explains an example of a backlight device 8 in Preferred Embodiment 2. In an arrangement of the backlight device 8, LXHL-PD01 (part number) fabricated by Philips Lumileds Lighting Company was used as a red light source 11R. Moreover, LXHL-PM01 (part number) fabricated by Philips Lumileds Lighting Company was used as a green light source 11G. Further, LXHL-PB01 (part number) fabricated by Philips Lumileds Lighting Company was used as a green light source 11B. First and second light diffusing members 13 and 14 that were used were the same as those in Preferred Embodiment 1. Other arrangements were also the same as arrangements of Preferred Embodiment 1.

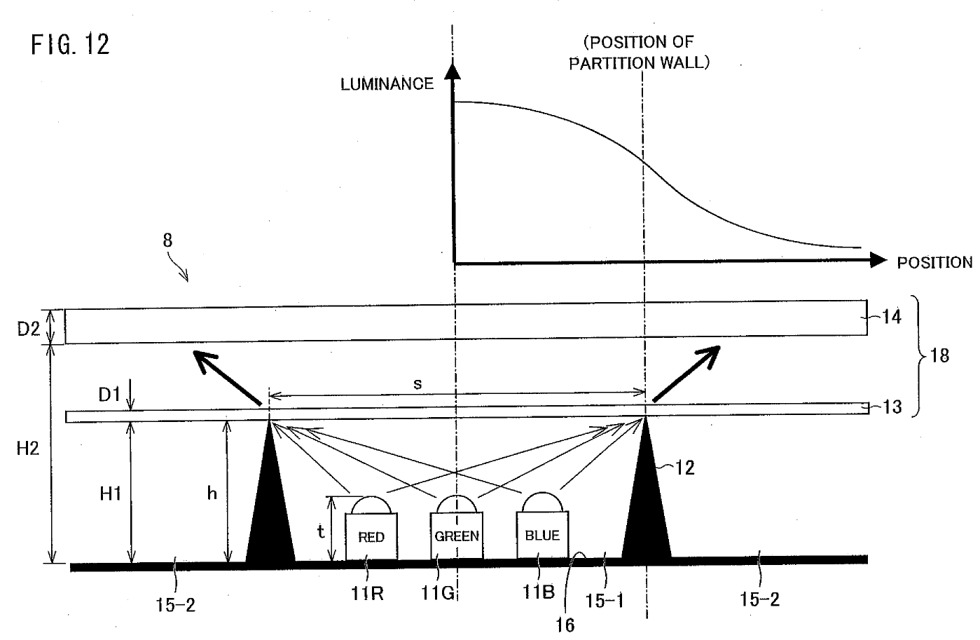

FIG. 12 illustrates a projection region of light from a light source 11 in a case where one illumination region 15-1 was in a bright state (lighting) and other illumination regions 15-2 were in a dark state (non lighting) in a backlight device 8 of Preferred Embodiment 3. An upper portion of FIG. 12 shows a result of study on a relationship between a luminance and a position of emitted light from a second light diffusing member 14.

The lights from light sources 11R, 11G, and 11B in the illumination region 15-1 in a bright state were first projected on the first light diffusing member 13. At this time, a projection region of a light from each of the light sources 11R, 11G, and 11B became identical. Therefore, an outline in accordance with a color of the light source 11 was not produced in an illumination light that had passed through the first light diffusing member 13 and was projected on the second light diffusing member 14. Therefore, a smooth luminance change as illustrated in an upper portion of FIG. 12 was obtained.

### Example 4

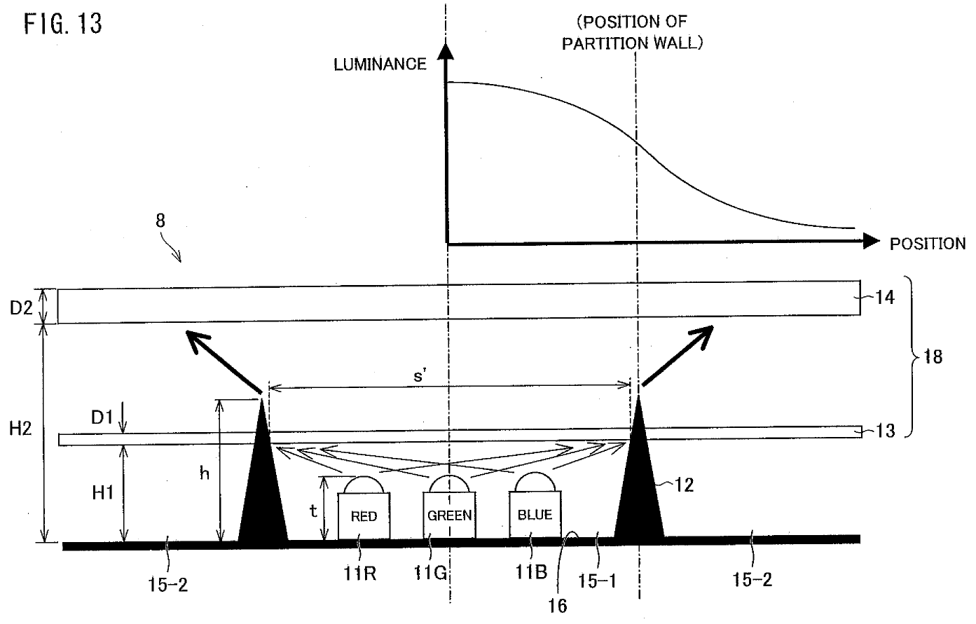

The following explains another Example of a backlight device 8 of Preferred Embodiment 2. This example was different from Preferred Embodiment 3 in a position of a first light diffusing member 13. Here, as illustrated in FIG. 13, a light incidence plane 13a of the first light diffusing member 13 was provided in a position lower than a top of a partition member 12. While a height h of the partition wall 12 from a light source disposition surface 16 was 25 (mm), a height H1 from the light source disposition surface 16 to the light incidence plane 13a of the first light diffusing member 13 was arranged to be 20 (mm). A height q (q=H2−h) of a second diffusing member 14 from the top of the partition wall 12 to a light incidence plane 14a was 15 (mm).

As with Preferred Embodiment 3, in this case, a projection region S′ of light on the first diffusing member 13 became identical. Here, the light was from each of light sources 11 in an illumination region 15-1 in a bright state. Therefore, an outline in accordance with a color of the light source 11 did not occur in an illumination light that was projected on the second light diffusing member 14. As a result, a smooth luminance change as illustrated in an upper portion of FIG. 13 could be obtained.

### Comparative Example 2

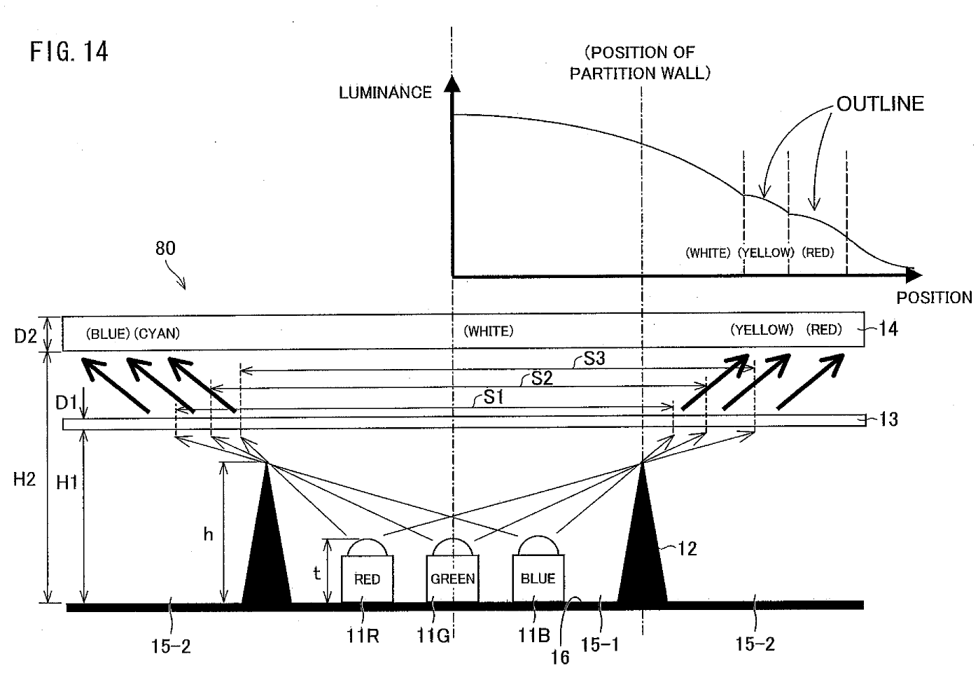

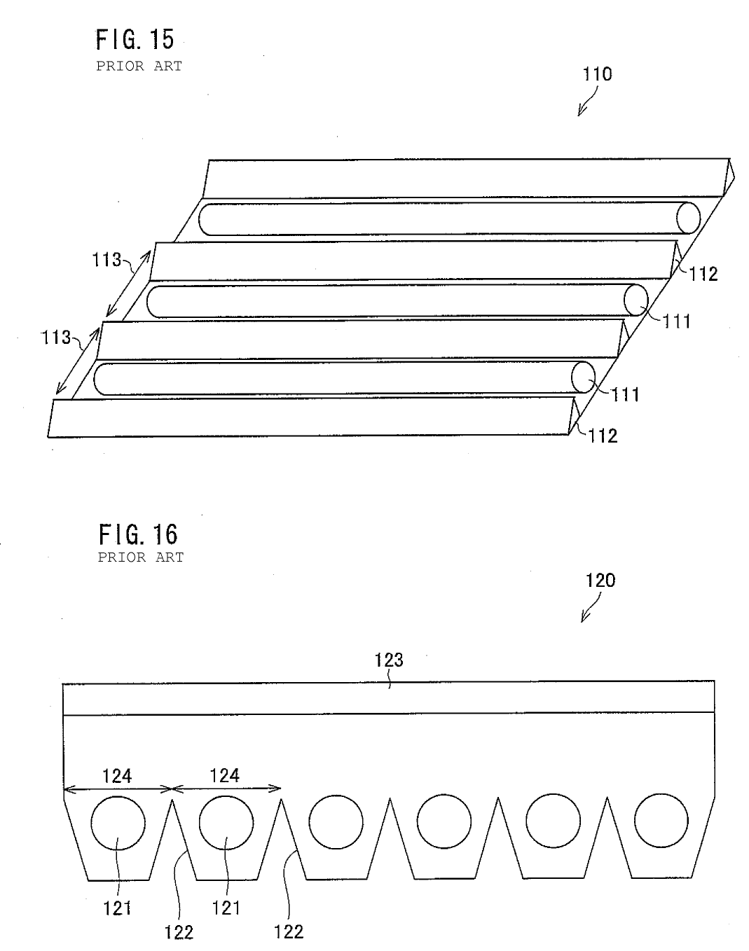

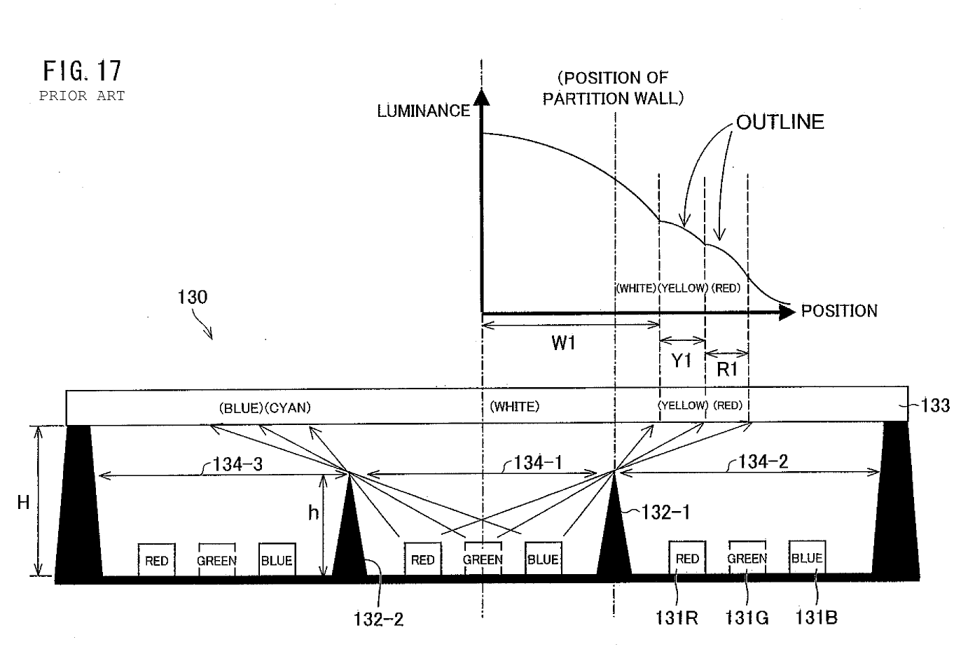

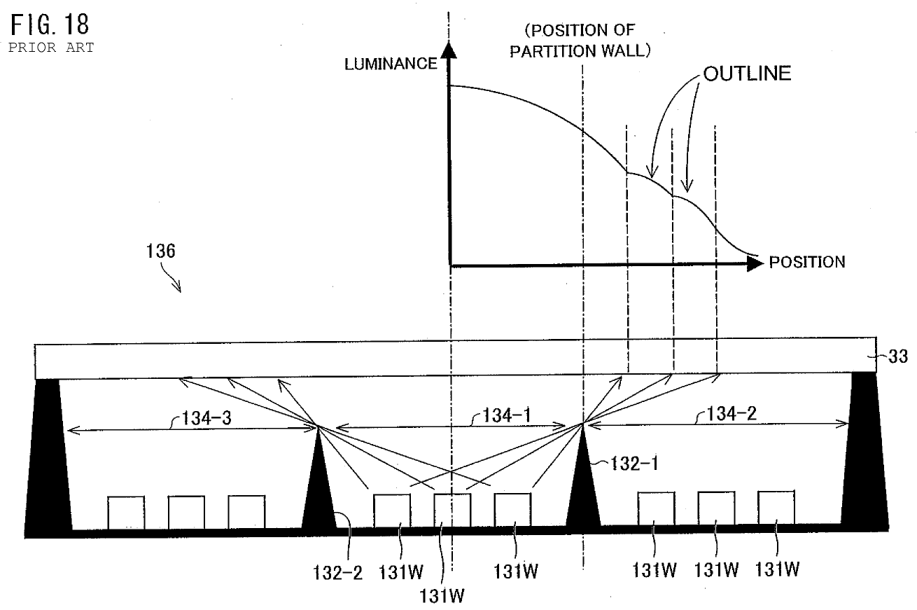

Meanwhile, in a backlight device 80 of a comparative example in which a first light diffusing member 13 was provided in a position higher than the partition wall 12, as illustrated in FIG. 14, projection regions s1, s2, and s3 of lights on the first light diffusing member 13 which lights were from respective light sources 11 in an illumination region 15-1 in a bright state differ from one another, depending on respective positions of the light sources in the illumination region 15-1. Therefore, as illustrated in an upper part of FIG. 14, a colored outline was produced in an illumination light that was projected on a second diffusing member 14. As a result, a uniform illumination was not obtained.

The present invention is applicable to a backlight device or the like of, for example, a liquid crystal display device characterized by a small thickness, low power consumption, high definition, or the like.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-6. (canceled)

7: An illumination device comprising:
a plurality of light sources;
a partition wall partitioning the plurality of light sources into a plurality of illumination regions so that one illumination region includes more than one of the plurality of light sources;
a first light diffusing member provided above the plurality of light sources, the first light diffusing member having a light incidence plane in a position at a height that is (i) higher than the plurality of light sources, and (ii) same as or lower than a top of the partition wall; and
a second light diffusing member which is provided so as to be laminated above the first light diffusing member so that a space is provided between the second diffusing member and the first diffusing member, the second light diffusing member having a light incidence plane in a position at a height that is higher than the top of the partition wall.

8: The illumination device as set forth in claim 7, wherein a distance between the light incidence plane which the second light diffusing member has and the top of the partition wall is set to a distance that does not produce a dark section in a vicinity of a section above the partition wall in a case where all the plurality of illumination regions are lit at a same brightness.

9: The illumination device as set forth in claim 7, wherein a Haze ratio of the second light diffusing member is equal to or more than a Haze ratio of the first light diffusing member.

10: The illumination device as set forth in claim 7, wherein a linear light transmittance of the first light diffusing member is equal to or greater than a linear light transmittance of the second light diffusing member.

11: The illumination device as set forth in claim 7, wherein a full width at half maximum of a transmitted diffused light obtained by entering a substantially parallel light into the second light diffusing member is equal to or more than a full width at half maximum of a transmitted diffused light obtained by entering a substantially parallel light into the first light diffusing member.

12: A liquid crystal display device comprising:
an illumination device as set forth in claim 7.
